(19) United States
(12) Patent Application Publication
(10) Pub. No.: US 2025/0328209 A1
(43) Pub. Date: Oct. 23, 2025

(54) Ultrasonic Sensing Device

(71) Applicant: Cypress Semiconductor Corporation, San Jose, CA (US)

(72) Inventors: Andriy Maharyta, Lviv (UA); Oleksandr Karpin, Lviv (UA)

(73) Assignee: Cypress Semiconductor Corporation, San Jose, CA (US)

(21) Appl. No.: 18/638,511

(22) Filed: Apr. 17, 2024

(51) Int. Cl. G06F 3/043; G06F 3/041

(52) U.S. Cl. CPC G06F 3/0436; G06F 3/04166

(57) ABSTRACT

A system and method for using quadrature demodulation to detect an event associated with a substrate. The method includes receiving an ultrasound signal associated with a substrate. The method includes performing quadrature demodulation of the ultrasound signal to generate an in-phase signal and a quadrature signal. The method includes detecting an event associated with the substrate based on the in-phase signal and the quadrature signal. The method includes providing a notification indicating the event.

### TECHNICAL FIELD

The present disclosure relates generally to the field of electronics, and more particularly, to an ultrasonic sensing device that overcomes the limitations of an Analog-to-Digital Converter (ADC).

### BACKGROUND

Touch sensing through surfaces or liquids using ultrasound signal is currently being investigated as an alternative to capacitive touch sensing principles. Ultrasonic sensing relies on the transmission of an ultrasound signal and the reception and processing of the reflected signal from the touch surface of a touch substrate. The characteristics (e.g., amplitude, phase shift, etc.) of the signal will depend on the existence or non-existence of a touch event.

### BRIEF DESCRIPTION OF THE DRAWINGS

The present disclosure is illustrated by way of example, and not by way of limitation, in the figures of the accompanying drawings in which like reference numerals refer to similar elements and in which:

FIG. 1 illustrates a block diagram of an example environment for using an ultrasonic sensing device to detect a human hand touching a substrate, according to some embodiments;

FIG. 2 illustrates a block diagram of an example ultrasonic sensing device that uses quadrature demodulation to detect a touch event associated with a substrate, according to some embodiments;

FIG. 3 illustrates a block diagram of an example environment for using a single differential synchronous rectificator that is part of a quadrature demodulator and a single differential ADC to serially capture I/Q signals, according to some embodiments;

FIG. 4 is a block diagram depicting example waveforms at the second terminal (the output) of the switches 303 of the quadrature demodulator 206 in FIG. 3, according to some embodiments;

FIG. 5 illustrates a block diagram of an example environment for using two differential synchronous rectificators that are part of a quadrature demodulator and two differential ADCs to simultaneously capture I/Q signals;

FIG. 6 illustrates a block diagram of an example environment for obtaining I/Q signals of an echo signal by combining multiple patterns of samples, according to some embodiments; and

FIG. 7 is a flow diagram of a procedure for using quadrature demodulation to detect an event associated with a substrate, according to some embodiments.

### DETAILED DESCRIPTION

The following description sets forth numerous specific details such as examples of specific systems, components, methods, and so forth, in order to provide a good understanding of various embodiments of the techniques described herein that are specifically designed to reduce the minimum requirements (e.g., sample rate, power consumption) of an Analog-to-Digital converter (ADC) to process an echo signal from an ultrasonic sensing device, where the echo signal is indicative of a sensing event (e.g., a human touch event, a presence or gesture event, etc.). It will be apparent to one skilled in the art, however, that at least some embodiments may be practiced without these specific details. In other instances, well-known components, elements, or methods are not described in detail or are presented in a simple block diagram format in order to avoid unnecessarily obscuring the techniques described herein. Thus, the specific details set forth hereinafter are merely exemplary. Particular implementations may vary from these exemplary details and still be contemplated to be within the scope of the present disclosure.

For simplicity of description, many embodiments discussed herein describe an ultrasonic sensing device for detecting when a human finger touches a touch substrate. However, it is understood that any of these embodiments may be configured to detect when any type of substrate touches the touch substrate, as well as to detect/measure level, proximity, presence, gesture, and/or the like.

Ultrasonic sensors (e.g. capacitive micromachined ultrasonic transducers CMUT, ultrasonic microphone, etc.) have unique properties including, for example, a miniature size, high Electromagnetic Compatibility (EMC) or low radiation, ultrasound can propagate through metals and liquids, and the ability to measure time-of-flight. For these reasons, ultrasonic sensors have potential to solve many challenging problems. For example, ultrasonic sensors can detect touch-under-anything because they can detect a human finger touch through several different types of material. Ultrasonic sensors can also measure level and proximity, as well as detect presence or gesture. The versatility of ultrasonic sensors make them useful in a wide range of applications, such as in medical, automotive, household appliances, robotics, and mobile phones. Other technologies, such as capacitive and inductive, have limitations in these areas.

An ultrasonic sensor can detect whether a particular touch material (e.g., metal, glass, etc.) has been touched by another material (e.g., a human finger) based on detecting a change in amplitude of an echo signal (e.g., a continuous ultrasound signal). That is, the ultrasonic sensor uses its transmitter to generate and direct an echo signal toward the touch material, which causes some or all of the echo signal to reflect off of the touch material. The ultrasonic sensor uses its receiver to capture the reflected echo signal and then uses processing circuitry to determine whether the amplitude of the reflected signal is meaningfully different than the amplitude of the echo signal, where the change in amplitude is caused, to at least some extent, by a change in acoustic impedance at a touch interface of the touch material. If there is a no-touch event, then the echo signal is almost totally reflected, thereby producing a reflected echo signal at the receiver of the ultrasonic sensor that has an amplitude matching or nearly matching the amplitude of the transmitted echo signal. Alternatively, in a touch condition, the material (e.g., a human finger) touching the touch material absorbs part of the ultrasound energy; thereby producing a reflected echo signal at the receiver that has an amplitude that is less than the amplitude of the transmitted echo signal.

The conventional processing circuitry includes filters, a rectifier, and an ADC. Specifically, the conventional ultrasonic sensor provides the reflected echo signal to a bandpass filter, whose filtered output is then provided to a rectifier, whose rectified output is then provided to a low-pass filter, and whose filtered output is then provided to an ADC. The ADC samples the filtered output of the low-pass filter at a particular sample rate to convert the filtered output (which corresponds to the reflected echo signal) to a digital signal and provides the digital signal to a post-processing device. The post-processing device uses the digital signal to detect whether a touch event has occurrence based on detecting a relatively small change in the amplitude of the echo signal.

However, inexpensive ADCs do not have a high enough maximum sampling rate to be able to detect and measure this relatively small change in the amplitude of the echo signal. Therefore, to reliably detect a touch event, the conventional ultrasonic sensor must include (or be paired with) an expensive, high-end ADC that has the requisite high sampling rate. Not only does this increase the monetary cost to implement the conventional design, it also increases the overall power consumption for the conventional design because an ADC with a higher sampling rate will consume more power.

Aspects of the disclosure address the above-noted and other deficiencies by using quadrature demodulation to detect a touch event associated with a substrate.

In an illustrative embodiment, an ultrasonic sensing device is coupled to a touch substrate (e.g., metal, glass) that is periodically being touched and untouched by one or more human fingers. The ultrasonic sensing device includes a transmitter/receiver (Tx/Rx) Micro Electro Mechanical Systems (MEMS), where the receiver also includes processing circuitry (e.g., filters, quadrature demodulator, ADC, and/or post-processors, etc.). In some embodiments, the processing circuitry may be included in one or more devices that are separate and downstream from the ultrasonic sensing device. The Tx/Rx MEMS acquires (e.g., receives) an echo signal (e.g., ultrasonic signal) associated with a touch substrate. For example, the Tx/Rx MEMS generates and transmits (e.g., directs) an echo signal toward the touch substrate, which causes some or all of the echo signal to reflect off of the touch substrate, and then uses its receiver to capture the reflected echo signal. The receiver then uses its processing circuitry to perform quadrature demodulation of the ultrasound signal to generate I/Q signals—e.g., an in-phase (I) signal and a quadrature (Q) signal. The processing circuitry of the ultrasonic sensing device detects a touch event associated with the touch substrate based on the in-phase signal and the quadrature signal.

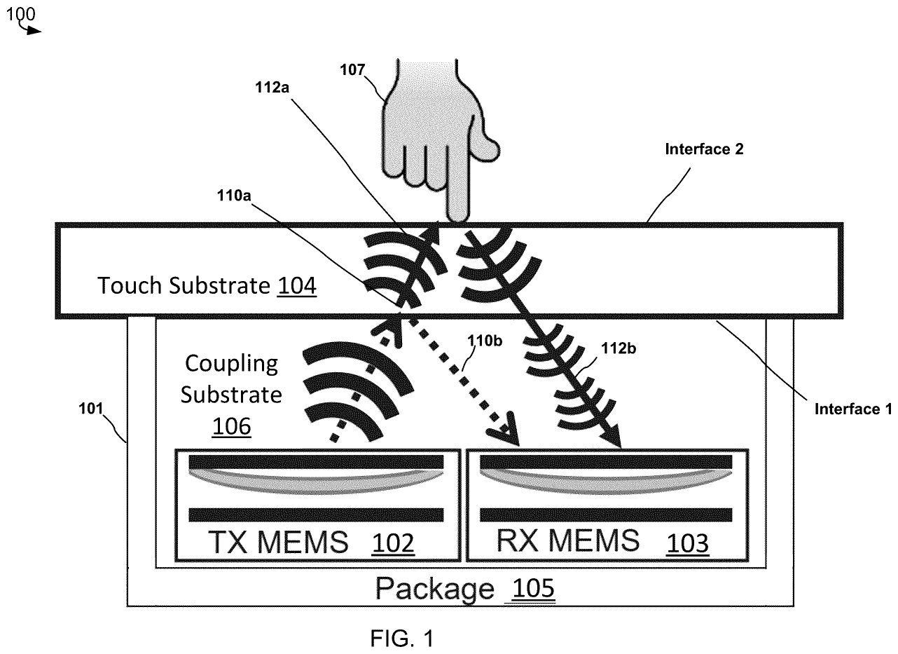

FIG. 1 illustrates a block diagram of an example environment for using an ultrasonic sensing device to detect a human hand touching a substrate, according to some embodiments. The environment 100 includes an ultrasonic sensing device 101 coupled to a touch substrate 104 (e.g., a screen of a smart phone). The ultrasonic sensing device 101 includes a TX MEMS 102 and an RX MEMS 103 that are each coupled to a first interface (shown in FIG. 1 as Interface 1) of the touch substrate 104 via a coupling substrate 106. The RX MEMS 103 includes processing circuitry (e.g., filters, quadrature demodulator, ADC, and/or post-processors, etc.) for processing the echo signals and reflected echo signals that are generated by the TX MEMS 102. In some embodiments, the processing circuitry may instead be included in one or more devices that are separate and downstream from the ultrasonic sensing device. One or more fingers of a human hand 107 are repeatedly touching the same and/or different regions of the touch substrate 104.

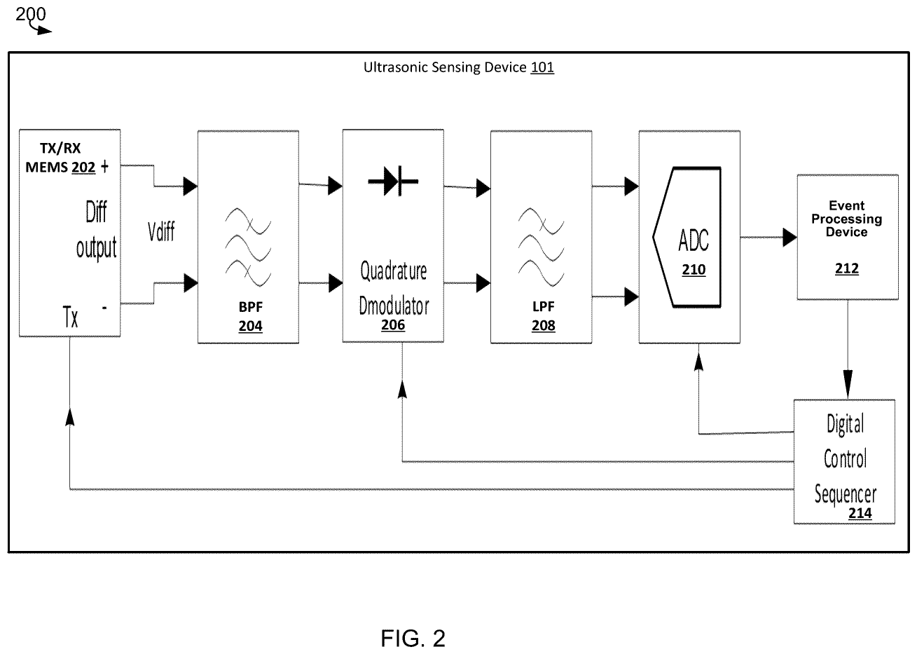

Although FIG. 2 shows that the ultrasonic sensing device 101 includes the processing circuitry (e.g., LPF 208, ADC 210, event processing device 212, digital control sequencer 214) for processing the output of the quadrature demodulator 206, other embodiments may move one or more of the components of the processing circuitry into other devices that are separate and downstream from the ultrasonic sensing device 101. For example, the ADC 210, the event processing device 212, and the digital control sequencer 214 may each reside in a device that is separate from the ultrasonic sensing device 101.

The ultrasonic sensing device 101 is configured to detect whether the human hand 107 is currently touching a second interface (shown in FIG. 1 as Interface 2) of the touch substrate 104. For example, at a time when a finger of the human hand 107 is not touching the touch substrate 104, the TX MEMS 102 generates and transmits an echo signal 110a through the coupling substrate 106 (e.g., metal, plastic, glass, liquid) and toward the touch substrate 104. The echo signal 110a impacts the first interface of the touch substrate 104, which causes all or nearly all of the echo signal 110a to reflect off of the first interface to produce a reflected echo signal 110b that is captured by the RX MEMS 103. The amplitude of the reflected echo signal 1120b matches or nearly matches the amplitude of the echo signal 112a.

Alternatively, at a time when a finger of the human hand 107 is touching the touch substrate 104, the TX MEMS 102 generates and transmits an echo signal 112a through the coupling substrate 106 and toward the touch substrate 104. However, when the echo signal 112a impacts the first interface of the touch substrate 104, some of the ultrasound energy of the echo signal 112a is absorbed by the human finger touching the touch substrate; thereby causing the amplitude of the resultant reflected echo signal 1120b to be less than the amplitude of the echo signal 112a.

FIG. 2 illustrates a block diagram of an example ultrasonic sensing device 101 that uses quadrature demodulation to detect a touch event associated with a substrate, according to some embodiments. The ultrasonic sensing device 101 includes a TX/RX MEMS 202 (a combination of the TX MEMS 102 and the RX MEMs 103 in FIG. 1) a bandpass filter (BPF) 204, a quadrature demodulator 206, a low-pass filter (LPF) 208), and ADC 210, an event processing device 212, and a digital control sequencer 214.

The differential outputs of the TX/RX MEMS 202 are coupled to the inputs of the BPF 204, whose outputs are coupled to the inputs of the quadrature demodulator 206, whose outputs are coupled to the inputs of the LPF 208, whose outputs are coupled to the input of the ADC 210, whose output is couped to the input of the event processing device 212, whose outputs is coupled to the input of the digital control sequencer 214. The output of the digital control sequencer 214 is fanned out to a third input of the ADC 210, a third input of the quadrature demodulator 206, and a Tx input of the TX/RX MEMS 202.

The TX/RX MEMS 202 includes a transmitter that is configured to generate and direct an echo signal toward the touch substrate 104. The TX/RX MEMS 202 includes a receiver that is configured to receive the reflected echo signal and provide the reflected echo signal to the BPF 204. The BPF 204 is configured to filter the reflected echo signal and provided the filtered signal to the quadrature demodulator 206.

The quadrature demodulator 206 is configured to perform quadrature demodulation of the filtered signal (e.g., an ultrasound signal) to generate a differential in-phase (I) signal and a differential quadrature (Q) signal. The quadrature demodulator 206 is configured to provide the differential I signal and the differential Q signal to the LPF 208.

The LPF 208 is configured to filter the differential I signal to generate a filtered differential I signal and provide the filtered differential I signal to the ADC. The LPF 208 is configured to filter the differential Q signal to generate a filtered differential Q signal and provide the filtered differential Q signal to the ADC 210.

The ADC 210 is configured to generate, using an ADC sample rate, a first digital signal based on the differential I signal and a second digital signal based on the differential Q signal.

The event processing device 212 is configured to detect, based on the first digital signal and the second digital signal, an event associated with the touch substrate 104 by detecting an amplitude change in the reflected echo signal providing a notification indicating the event. The event processing device 212 generates an output (“event flag”) indicating an event (e.g., touching event, proximity event, level event, gesture event, presence event, etc.) associated with the touch substrate 104 has occurred.

The event processing device 212 sends the event flag to the ADC 210, the quadrature demodulator 206, and the TX/RX MEMS 202 to support various modes of the ultrasonic sensing device 101, depending on the particular application. For example, the ultrasonic sensing device 101 may configure the TX/RX MEMS 202 as a proximity sensor to determine that a user is not near the touch substrate 104, and in response, configure the TX/RX MEMS 202 into a low-power state (“wake-on-touch mode”) that forces the TX/RX MEMS 202 to use a lower scan/refresh rate (e.g., 1 HZ) when checking for events. If the event processing device 212 determines that the user is now near the touch substrate 104, then the digital control sequencer 214 can send the event flag to the TX/RX MEMS 202 to force the TX/RX MEMS 202 to wake and return to the normal-power mode and then use the normal (e.g., 120 HZ) scan/refresh rate when checking for the same type of event (e.g., proximity) or other types of events (e.g., gestures, touch, etc.).

The ultrasonic sensing device 101 can control the time windows in which the TX/RX MEMS 202 generates echo signals (“excitation” phase) and the time windows in which the processing circuitry waits to receive the echo signals (“listening” phase) by having the digital control sequencer 214 send timing signals to the Tx input of the TX/RX MEMS 202 to force the TX/RX MEMS 202 to generate echo signals. For example, the digital control sequencer 214 sends a first timing signal to the TX/RX MEMS 202 and then waits and listens for the TX/RX MEMS 202 to generate a first echo signal. The digital control sequencer 214 then sends a second timing signal the TX/RX MEMS 202 and then waits and listens for the TX/RX MEMS 202 to generate a second echo signal. Thus, the excitation phase and the listening phase are time separated.

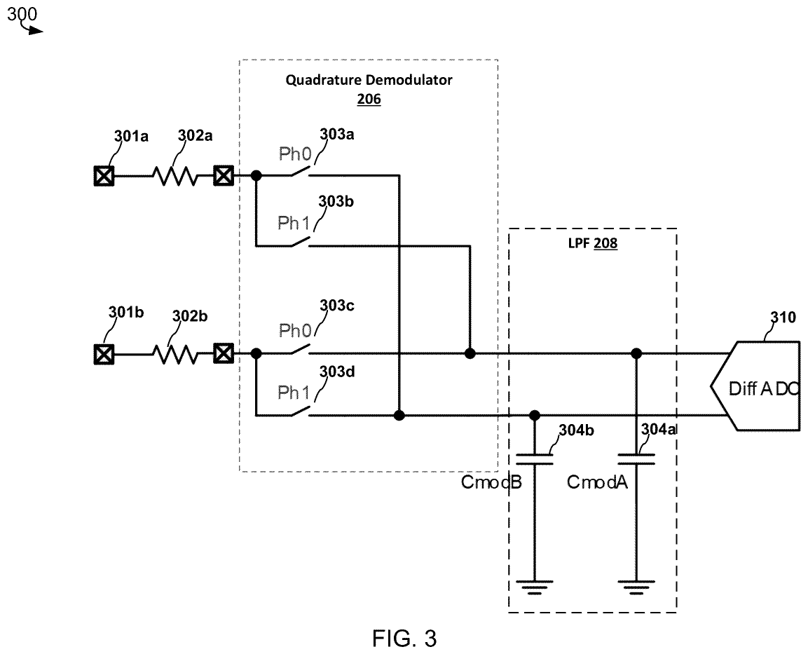

FIG. 3 illustrates a block diagram of an example environment for using a single differential synchronous rectificator that is part of a quadrature demodulator and a single differential ADC to serially capture I/Q signals, according to some embodiments. Specifically, the environment 300 shows a quadrature demodulator 206 that is based on differential synchronous rectifier that is controlled by different digital signals pairs that include the following signal properties: they align to a common sensing start signal (e.g., Tx signal) received at the Tx input of TX/RX MEMS 202 in FIG. 2), they are shifted by 90 degree from each other, and/or they are active in different scanning frames.

As shown in FIG. 3, the quadrature demodulator 206 (e.g., a differential synchronous rectifier) includes analog switches 303—e.g., switch 303a (Ph0), switch 303b (Ph1), switch 303c (Ph0), and switch 303d (Ph1). The LPF 208 includes capacitors 304—e.g., capacitor 304a (CmodA) and capacitor 304b (CmodB).

The positive output of BPF 204 in FIG. 2 is coupled to the positive input 301a, which is coupled to a first terminal of resistor 302a, whose second terminal is coupled to a first input of the quadrature demodulator 206. The negative output of BPF 204 in FIG. 2 is coupled to the negative input 301b, which is coupled to a first terminal of resistor 302b, whose second terminal is coupled to a second input of the quadrature demodulator 206.

The first input of the quadrature demodulator 206 is coupled to a first terminal of the switch 303a (Ph0), whose second terminal is coupled to a first input of the LPF 208. The first input of the quadrature demodulator 206 is also coupled to a first terminal of the switch 303b (Ph1), whose second terminal is coupled to a second input of the LPF 208.

The second input of the quadrature demodulator 206 is coupled to a first terminal of the switch 303c (Ph0), whose second terminal is coupled to a first input of the LPF 208. The second input of the quadrature demodulator 206 is also coupled to a first terminal of the switch 303d (Ph1), whose second terminal is coupled to a second input of the LPF 208.

The signal on the first input of the LPF 208 is driven out of the LPF 208 via a first output of the LPF 208 and into a first input of the ADC 310. The signal on the second input of the LPF 208 is driven out of the LPF 208 via a second output of the LPF 208 and into a second input of the ADC 310.

Thus, the quadrature demodulator 206 captures I and Q at different time serially and digital control changes the Ph0 and Ph1 to Ph0_90 and Ph1_90 for I and Q correspondently.

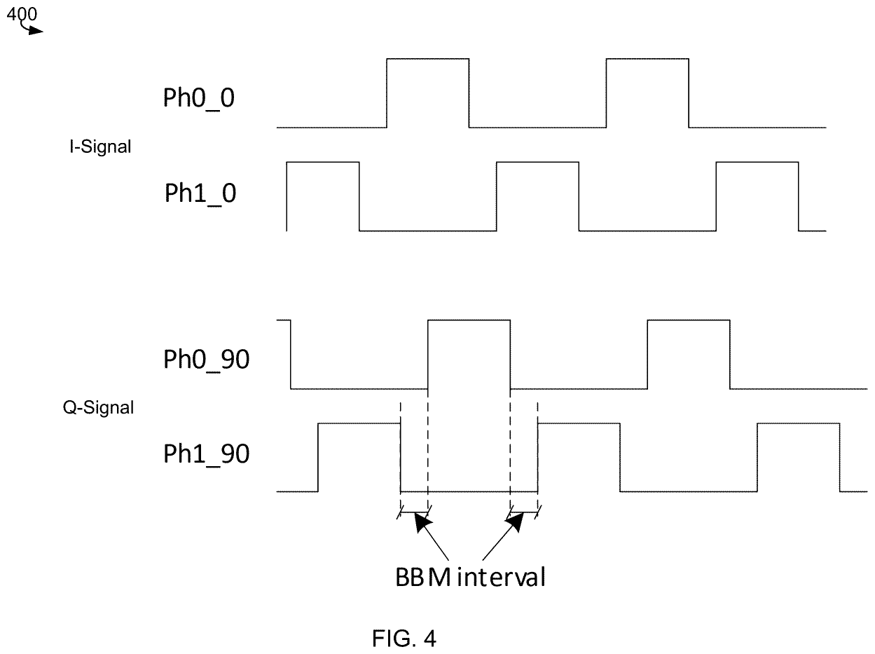

FIG. 4 is a block diagram depicting example waveforms at the second terminal (the output) of the switches 303 of the quadrature demodulator 206 in FIG. 3, according to some embodiments. The block diagram 400 shows the break before make (BBM) interval between the falling edge of the Ph1_90 waveform and the rising edge of the Ph0_90 waveform. The ultrasonic sensing device 101 may adjust the BBM to reduce or eliminate cross-talk current within the quadrature demodulator 206.

Referring to FIGS. 3 and 4, the ultrasonic sensing device 101 processes an in-phase signal of an echo signal and the quadrature signal of the echo signal during different time windows because the quadrature demodulator 206 only includes a single ADC 310. Specifically, during a first time window, the digital control sequencer 214 configures the quadrature demodulator 206 to generate an in-phase signal from an echo signal. The digital control sequencer 214 then sends a start signal (Tx signal) to the Tx input of the TX/RX MEMS 202 to cause the TX/RX MEMS 202 to generate the echo signal. The signal that controls the switches 303 of the quadrature demodulator 206 has the same frequency as the Tx signal and is strongly synchronized with the Tx signal. The quadrature demodulator 206 generates a differential in-phase signal from the echo signal (shown in FIG. 4 as a pulse train) and the ADC 210 generates a first ADC signal from the in-phase signal by sampling the differential in-phase signal using a particular sample rate. Likewise, during a second time window, the digital control sequencer 214 configures the quadrature demodulator 206 to generate a quadrature signal from the echo signal. The quadrature demodulator 206 then generates a differential quadrature signal from the echo signal (also shown in FIG. 4 as a pulse train) and the ADC 210 generates a second ADC signal from the quadrature signal by sampling the differential quadrature signal using the particular sample rate.

The ultrasonic sensing device 101 uses the first ADC signal and the second ADC signal to detect whether an event (e.g., touching event, proximity event, level event, gesture event, presence event, etc.) associated with the touch substrate 104 has occurred by determining there has been a change in the amplitude of the echo signal.

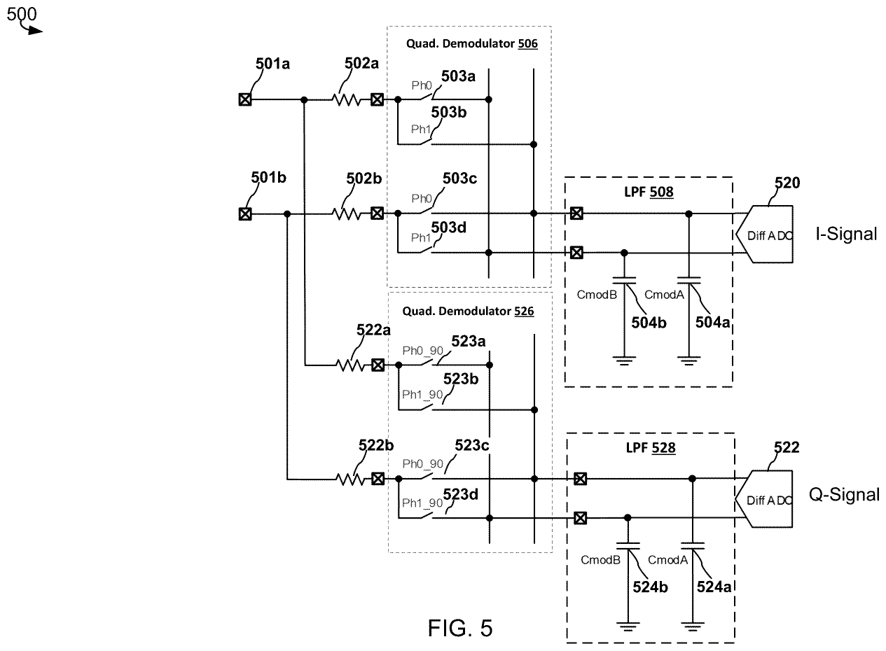

FIG. 5 illustrates a block diagram of an example environment for using two differential synchronous rectificators that are part of a quadrature demodulator and two differential ADCs to simultaneously capture I/Q signals. The environment 500 shows twice the number of components that are shown in FIG. 3. Specifically, the environment 500 shows a quadrature demodulator 506, quadrature demodulator 526. The quadrature demodulator 506 includes analog switches 503—e.g., switch 503a (Ph0), switch 503b (Ph1), switch 503c (Ph0), and switch 503d (Ph1). The quadrature demodulator 526 includes analog switches 523—e.g., switch 523a (Ph0), switch 523b (Ph1), switch 523c (Ph0), and switch 523d (Ph1).

The LPF 508 includes capacitors 504—e.g., capacitor 504a (CmodA) and capacitor 504b (CmodB). The LPF 528 includes capacitors 524—e.g., capacitor 524a (CmodA) and capacitor 524b (CmodB).

The positive output of BPF 204 in FIG. 2 is coupled to the positive input 501a, which is coupled to a first terminal of resistor 502a and a first terminal of resistor 522a. The negative output of BPF 204 in FIG. 2 is coupled to the negative input 501b, which is coupled to a first terminal of resistor 502b and a first terminal of resistor 522b.

Thus, the ultrasonic sensing device 101 can use the embodiment depicted in FIG. 5 to process the I/Q signals of an echo signal during the same time window and in parallel because the ultrasonic sensing device 101 can (1) process the in-phase signal of an echo signal using the quadrature demodulator 506, the LPF 508, and the ADC 520, and (2) process the quadrature signal of the echo signal using the quadrature demodulator 526, the LPF 528, and the ADC 522.

Furthermore, the quadrature demodulators 506, 526 are not sensitive to currier frequency phase variation. The quadrature demodulators 506, 526 have frequency selective properties. The ultrasonic sensing device 101 calculates signals magnitude. For example, the ultrasonic sensing device 102 may use a microcontroller programming procedure (e.g., FW) to calculate the signals magnitude. The phase shift between the rectifier sync signal may be 90 degrees. The FW signal pass calculates signal magnitude based on I and Q signal part.

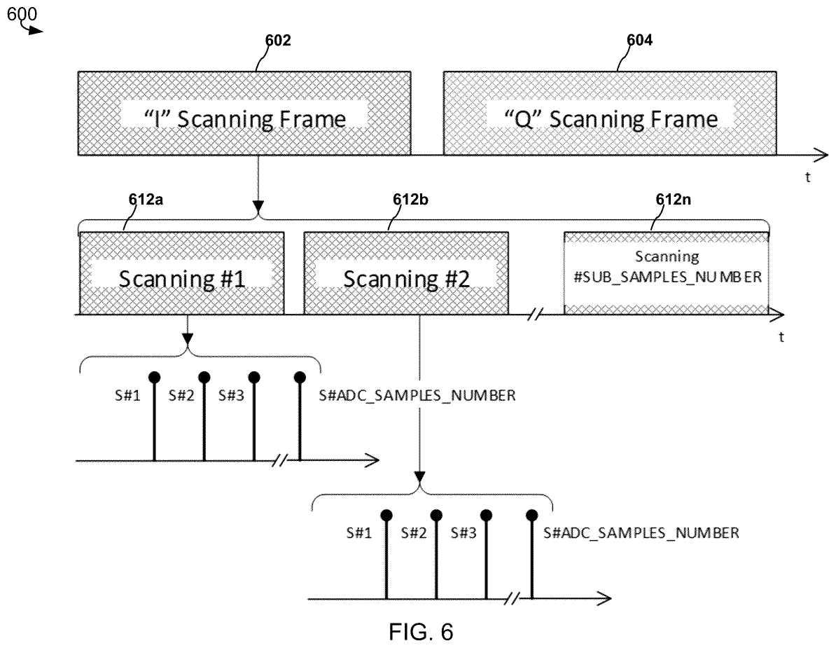

FIG. 6 illustrates a block diagram of an example environment for obtaining I/Q signals of an echo signal by combining multiple patterns of samples, according to some embodiments. The ultrasonic sensing device 101 may use a scanning procedure that is based on gathering and processing multiple scanning frames to increase a time domain resolution and without having to increase a sampling rate of the ADC to process scanning frames. Specifically, as shown in FIG. 6, the ultrasonic sensing device 101 may capture a scanning frame 602 of an echo signal and generate in-phase values based on the scanning frame 602. The ultrasonic sensing device 101 then captures a scanning frame 604 of the same echo signal (or a different echo signal) and generates quadrature values based on the scanning frame 604.

Each scanning frame includes sampling series. The ultrasonic sensing device 101 captures groups (e.g., patterns) of sampling series 612 from each scanning frame. For example, the ultrasonic sensing device 101 acquires sampling series 612a (scanning #1), sampling series 612b (scanning #2), and up to sampling series 612n (scanning #n).

Each sampling series 612 includes sampling data points. For example, sampling series 612a includes a first ADC data point (S #1), a second ADC data point (S #2), and a third ADC data point (S #3). Sampling series 612b includes a first ADC data point (S #1), a second ADC data point (S #2), and a third ADC data point (S #3). The ADC data points in sampling series 612b are different from the ADC data points in sampling series 612b because the sampling series 612a corresponds to a first time window and the sampling series 612b corresponds to a second time window.

The ultrasonic sensing device 101 obtains the in-phase signal and quadrature signal by combining multiple patterns of samples according to the following equations (1)-(3):

S1=S#1 from sampling series 612a+S#1 from sampling series 612b+ . . . +S#1 from sampling series 612n (1)

S2=S#2 from sampling series 612a+S#2 from sampling series 612b+ . . . +S#2 from sampling series 612n (2)

SADC_SAMPLES_NUMBER=S#ADC_SAMPLES_NUMBER of sampling series 612a+S#ADC_SAMPLES_NUMBER of sampling series 612b+ . . . +S#ADC_SAMPLES_NUMBER of sampling series 612n (3)

Each sampling series 612 has a self-demodulator signal phase. In some embodiments, the number of sensor sampling may be more than 10. In some embodiments, the number of sensor sampling may be defined by scanning performance requirements. In some embodiments, all sampling series 612 have the same demodulator signal phase. In some embodiments, the ultrasonic sensing device 101 can increase the number (e.g., 4) of scanning frames to increase time domain resolution.

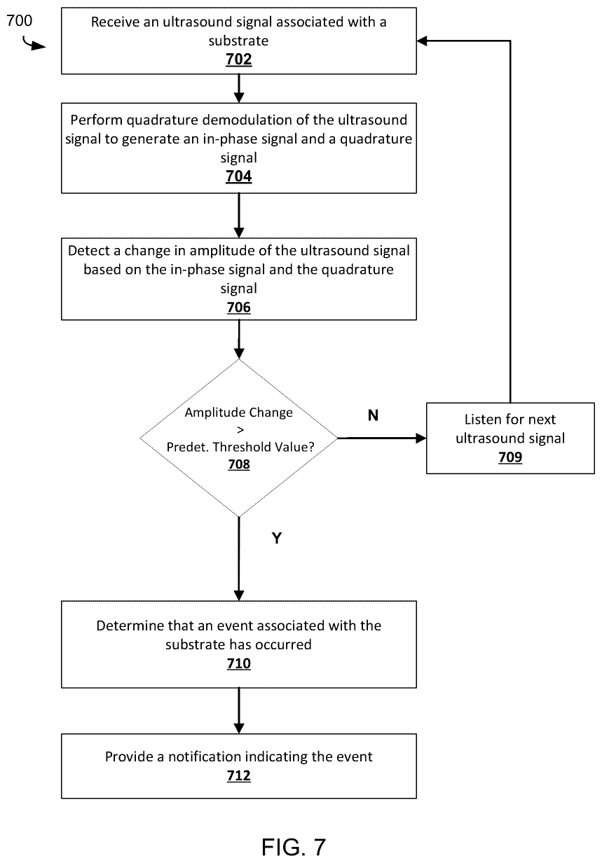

FIG. 7 is a flow diagram of a procedure for using quadrature demodulation to detect an event associated with a substrate, according to some embodiments. Although the operations are depicted in FIG. 7 as integral operations in a particular order for purposes of illustration, in other implementations, one or more operations, or portions thereof, are performed in a different order, or overlapping in time, in series or parallel, or are omitted, or one or more additional operations are added, or the method is changed in some combination of ways. In some embodiments, the procedure 700 may be performed by processing logic that includes hardware (e.g., circuitry, dedicated logic, programmable logic, microcode, etc.), firmware, or a combination thereof. In some embodiments, some or all operations of procedure 700 may be performed by one or more components (e.g., TX/RX MEMS 202, BPF 204, quadrature demodulator 206, LPF 208, ADC 210, event processing device 212, digital control sequencer 214) of the ultrasonic sensing device 101.

At operation 702, in some embodiments, the ultrasonic sensing device 101 receives an ultrasound signal (e.g., an echo signal, a reflected ultrasound signal) associated with a substrate. At operation 704, in some embodiments, the ultrasonic sensing device 101 performs quadrature demodulation of the ultrasound signal to generate an in-phase signal and a quadrature signal.

At operation 706, in some embodiments, the ultrasonic sensing device 101 detects a change in amplitude of the ultrasound signal based on the in-phase signal and the quadrature signal. At operation 708, in some embodiments, the ultrasonic sensing device 101 may determine whether the change in amplitude is greater than a predetermined threshold (e.g., 100 millivolts). If the change in amplitude is not greater than the predetermined threshold, then the ultrasonic sensing device 101 proceeds to operation 709 to listen for the next ultrasound signal and operation 702 to receive the next ultrasound signal.

However, if the logic circuit 130 determines that the change in amplitude is greater than the predetermined threshold, then the ultrasonic sensing device 101 proceeds to operation 710 where it determines that an event associated with the substrate has occurred.

At operation 712, in some embodiments, the ultrasonic sensing device 101 provides a notification indicating the event. For example, the ultrasonic sensing device 101 may present the notification on a display or send the notification to a computing device.

In the above description, some portions of the detailed description are presented in terms of algorithms and symbolic representations of operations on analog signals and/or digital signals or data bits within a non-transitory storage medium. These algorithmic descriptions and representations are the means used by those skilled in the data processing arts to most effectively convey the substance of their work to others skilled in the art. An algorithm is here and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared and otherwise manipulated. It has proven convenient at times, principally for reasons of common usage, to refer to these signals as bits, values, elements, symbols, characters, terms, numbers, or the like.

Reference in the description to “an embodiment,” “one embodiment,” “an example embodiment,” “some embodiments,” and “various embodiments” means that a particular feature, structure, step, operation, or characteristic described in connection with the embodiment(s) is included in at least one embodiment of the disclosure. Further, the appearances of the phrases “an embodiment,” “one embodiment,” “an example embodiment,” “some embodiments,” and “various embodiments” in various places in the description do not necessarily all refer to the same embodiment(s).

The description includes references to the accompanying drawings, which form a part of the detailed description. The drawings show illustrations in accordance with exemplary embodiments. These embodiments, which may also be referred to herein as “examples,” are described in enough detail to enable those skilled in the art to practice the embodiments of the claimed subject matter described herein. The embodiments may be combined, other embodiments may be utilized, or structural, logical, and electrical changes may be made without departing from the scope and spirit of the claimed subject matter. It should be understood that the embodiments described herein are not intended to limit the scope of the subject matter but rather to enable one skilled in the art to practice, make, and/or use the subject matter.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “receiving,” “performing,” “detecting,” “providing,” “generating,” “adjusting,” “determining,” or the like, refer to the actions and processes of an integrated circuit (IC) controller, or similar electronic device, that manipulates and transforms data represented as physical (e.g., electronic) quantities within the controller's registers and memories into other data similarly represented as physical quantities within the controller memories or registers or other such information non-transitory storage medium.

The words “example” or “exemplary” are used herein to mean serving as an example, instance, or illustration. Any aspect or design described herein as “example’ or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “one embodiment” or “an embodiment” or “one embodiment” throughout is not intended to mean the same embodiment or embodiment unless described as such.

Embodiments described herein may also relate to an apparatus (e.g., such as an AC-DC converter, and/or an ESD protection system/circuit) for performing the operations herein. This apparatus may be specially constructed for the required purposes, or it may include firmware or hardware logic selectively activated or reconfigured by the apparatus. Such firmware may be stored in a non-transitory computer-readable storage medium, such as, but not limited to, read-only memories (ROMs), random access memories (RAMs), EPROMS, EEPROMs, flash memory, or any type of media suitable for storing electronic instructions. The term “computer-readable storage medium” should be taken to include a single medium or multiple media that store one or more sets of instructions. The term “computer-readable medium” shall also be taken to include any medium that is capable of storing, encoding, or carrying a set of instructions for execution by the machine and that causes the machine to perform any one or more of the methodologies of the present embodiments. The term “computer-readable storage medium” shall accordingly be taken to include, but not be limited to, solid-state memories, optical media, magnetic media, any medium that is capable of storing a set of instructions for execution by the machine and that causes the machine to perform any one or more of the methodologies of the present embodiments.

The above description sets forth numerous specific details such as examples of specific systems, components, methods, and so forth, in order to provide a good understanding of several embodiments of the present disclosure. It is to be understood that the above description is intended to be illustrative and not restrictive. Many other embodiments will be apparent to those of skill in the art upon reading and understanding the above description. The scope of the disclosure should, therefore, be determined with reference to the appended claims, along with the full scope of equivalents to which such claims are entitled.

What is claimed is:

1. A method comprising:
receiving an ultrasound signal associated with a substrate;
performing quadrature demodulation of the ultrasound signal to generate an in-phase signal and a quadrature signal;
detecting an event associated with the substrate based on the in-phase signal and the quadrature signal; and
providing a notification indicating the event.

2. The method of claim 1, further comprising:
adjusting a time window associated with receiving the ultrasound signal based on at least one of an event type of the event, a substrate type of the substrate, or a substrate type of a different substrate that is coupled to the substrate.

3. The method of claim 1, wherein detecting the event associated with the substrate based on the in-phase signal and the quadrature signal further comprises:
detecting a change in amplitude of the ultrasound signal; and
determining that the change exceeds a predetermined threshold value.

4. The method of claim 1, wherein detecting the event comprises at least one of:
detecting that a different substrate has physically touched the substrate;
detecting that the different substrate is proximate to the substrate; or
detecting a human gesture.

5. The method of claim 1, wherein performing the quadrature demodulation of the ultrasound signal to generate the in-phase signal and the quadrature signal is further based on a plurality of switches.

6. The method of claim 5, further comprising:
generating the ultrasound signal based on a first signal; and
controlling the plurality of switches based on a second signal that is synchronized with the first signal.

7. The method of claim 5, wherein detecting the event associated with the substrate based on the in-phase signal and the quadrature signal further comprises:
using, during a first time window, an analog-to-digital converter (ADC) to process the in-phase signal; and
using, during a second time window, the ADC to process the in-phase signal.

8. The method of claim 5, wherein a first pair of switches of the plurality of switches is exclusively used to generate in-phase signals and a second pair of switches of the plurality of switches is exclusively used to generate quadrature signals.

9. The method of claim 1, further comprising:
generating a scanning frame based on the ultrasound signal;
acquiring a first portion of the scanning frame and a second portion of the scanning frame; and
generating, using a sample rate, a first group of digital values based on the first portion of the scanning frame and a second group of digital values based on the second portion of the scanning frame, wherein the sample rate is lower than a minimum sample rate to process the scanning frame.

10. The method of claim 9, wherein the first group of digital values and the second group of digital values are each associated with a time domain resolution, and further comprising:
combining the first group of digital values and the second group of digital values to generate a combined group of digital values associated with an increased time domain resolution that is greater than the time domain resolution.

11. An integrated circuit, comprising:
an ultrasound sensing device configured to receive an ultrasound signal associated with a substrate;
a quadrature demodulator coupled to the ultrasound sensing device, wherein the configured quadrature demodulator is configured to perform quadrature demodulation of the ultrasound signal to generate an in-phase signal and a quadrature signal; and
a processing device coupled to the quadrature demodulator, wherein the processing device is configured to detect an event associated with the substrate based on the in-phase signal and the quadrature signal and provide a notification indicating the event.

12. The integrated circuit of claim 11, the processing device is further configured to:
adjust a time window associated with receiving the ultrasound signal based on at least one of an event type of the event, a substrate type of the substrate, or a substrate type of a different substrate that is coupled to the substrate.

13. The integrated circuit of claim 11, wherein the processing device is further configured to:
detect a change in amplitude of the ultrasound signal; and
determine that the change exceeds a predetermined threshold value.

14. The integrated circuit of claim 11, wherein the processing device is further configured to:
detect that a different substrate has physically touched the substrate;
detect that the different substrate is proximate to the substrate; or
detect a human gesture.

15. The integrated circuit of claim 11, further comprising:
a plurality of switches,
wherein to perform the quadrature demodulation of the ultrasound signal to generate the in-phase signal and the quadrature signal is further based on the plurality of switches.

16. The integrated circuit of claim 15, wherein the processing device is further configured to:
generate the ultrasound signal based on a first signal; and
control the plurality of switches based on a second signal that is synchronized with the first signal.

17. The integrated circuit of claim 15, wherein to detect the event associated with the substrate based on the in-phase signal and the quadrature signal, the processing device is further configured to:
use, during a first time window, an analog-to-digital converter (ADC) to process the in-phase signal; and
use, during a second time window, the ADC to process the in-phase signal.

18. The integrated circuit of claim 15, wherein a first pair of switches of the plurality of switches is exclusively used to generate in-phase signals and a second pair of switches of the plurality of switches is exclusively used to generate quadrature signals.

19. The integrated circuit of claim 11, wherein the processing device is further configured to:
generate a scanning frame based on the ultrasound signal;
acquire a first portion of the scanning frame and a second portion of the scanning frame; and
generate, using a sample rate, a first group of digital values based on the first portion of the scanning frame and a second group of digital values based on the second portion of the scanning frame, wherein the sample rate is lower than a minimum sample rate to process the scanning frame.

20. A method comprising:
generating a plurality of ultrasound signals indicative of a plurality of different event types associated with a substrate;
performing quadrature demodulation of the plurality of ultrasound signals to generate a plurality of in-phase signals and a plurality of quadrature signals; and
detecting each different event type of the plurality of different event types based on the plurality of in-phase signals and the plurality of quadrature signals.
